(19) United States
(12) Patent Application Publication
(10) Pub. No.: US 2015/0377315 A1
(43) Pub. Date: Dec. 31, 2015

(54) Cylinder Tube Closed At The End So As To Be Fluid-Tight And Method For Production Thereof

(71) Applicant: SCHMITTERGROUP AG, Thüngen (DE)

(72) Inventors: Friedhelm Gunther, Dortmund (DE); Marco Schmidt, Thungen (DE); Ralf Dirscherl, Thungen (DE)

(73) Assignee: SchmitterGroup AG, Thungen (DE)

(21) Appl. No.: 14/438,656

(22) PCT Filed: Nov. 28, 2012
(86) PCT No.: PCT/EP2012/073867

§ 371 Date: Aug. 7, 2015

(51) Int. Cl. F16F 9/32; B21C 37/16; B23P 15/00; B21C 1/24

(52) U.S. Cl. CPC F16F 9/3242; B21C 1/24; B21C 37/16; B23P 15/00; F16F 9/3235; B23P 2700/50; F16F 2226/048

(57) ABSTRACT

A method for producing a cylinder tube (2), which is closed at the end so as to be fluid-tight, from a tubular blank (30). The blank (30) is formed into the cylinder tube (2) with the aid of a cold forming method in such a way that on an end region (6) of the cylinder tube (2) an opening (8) remains in the cylinder tube (30), a mounting region (12) is produced in the radially outer edge region (10) of the end region (6) and the cylinder tube (2) is closed by fluid-tight attachment on the mounting region (12) of an end piece (14) which closes the opening (8). A cylinder tube (2) comprises the cylinder tube (2) cold formed from the blank (30) having an opening (8) at the end, the mounting region (12) and an end piece (14) attached to the mounting region (12) so as to be fluid-tight.

### BACKGROUND OF THE INVENTION

The invention relates to a cylinder tube that is closed at the end so as to be fluid-tight and method for production thereof. Such a cylinder tube is used in particular as or for further processing into a shock absorber tube for a shock absorber of a motorized vehicle, i.e. a cylinder tube component for a motorized vehicle shock absorber, which are generally provided with a weld-on mounting bracket. “Fluid-tight” means leakproofness against liquids and/or gas. In this case, this particularly addresses gas-proof cylinder tubes.

It is known to produce such type of cylinder tube from precision tubing, such as DIN EN 10305-2, E235 +C. The precision tubing will then be sealed as to be fluid-tight by cold forming and/or thermoforming on the desired tube end or the respective front end. A mounting is then welded onto the thick-walled base or tube base so formed, forming a weld-on mounting. The holder normally has the shape of a fork or a ring, also named eyelet. A corresponding ring mounting then also makes it possible to insert or fit a rubber mount. The mounting is used for fastening the shock absorber onto the automotive body or onto the suspension components. The rubber mount, also called rubber-bonded metal mount, usually serves to prevent rattling noise.

It is also known to produce such cylinder tube by means of deep drawing processes involving a very great number of metal forming stages and intermediate annealing. The weld-on mounting bracket is then welded onto the base that is already molded onto the cylinder tube, i.e. the tube base.

The object of the invention is to indicate an improved cylinder tube as well as an improved method for its production.

### SUMMARY OF THE INVENTION

In terms of the method, the objective is solved by a method according to claim 1. The method in particular serves for producing a cylinder tube in the form of a shock absorber tube of a shock absorber of a motorized vehicle. The cylinder tube is produced from a tubular blank. This particularly comprises a constant wall thickness, both in the circumferential direction as well as in the axial direction. The method comprises the following steps:

The blank is initially formed in the desired geometry and quality into a cylinder tube by means of a cold forming process. The blank consists of a material suitable for deforming by cold forming, particularly a longitudinally welded, normalized steel tube. Here, in particular the cold forming process is a possibility for sheet metal deep-drawing, also called ironing. The forming is done in such a way that an opening remains in the blank or in the cylinder tube, if the end region of the cylinder tube is to be sealed to be fluid-tight. In other words, no sealed tube base is produced on the blank itself. In a further process step, a mounting region is produced in the radially outer edge region for the subsequent attachment of an end piece. The cylinder tube is sealed in a further process step, in that an end piece that seals the end piece fluid-tight is attached as to be fluid-tight in the mounting region. The attaching is done particularly by fluid-tight welding. The mounting region then is a suitable weld zone for welding, which is also suitably sized for the welding process, i.e. sufficient load rating, thickness, strength, etc. By attaching the end piece, this will produce a fluid-tight tube base on the cylinder tube.

The method as taught by the invention offers the advantage that the cylinder tube can have the respective desired, i.e. specific, wall thicknesses and strengths in the cold formed regions. Because these properties can be adequately adjusted or accomplished by suitable parameterization of the deformation process. The setting of the specific wall thickness and strength is adjustable in the cold formed regions, for example by the thickness and base material of the blank, pretreatment of the blank, and the form of a blank used for ironing. During cold forming, therefore particularly the wall strength or wall thickness and/or the inner and/or the outside diameter of the blank is varied, particularly by one-time or repeated sheet metal deep-drawing, as a result of which the blank normally extends in the axial direction.

If necessary, following the cold forming, the cylinder tube will be cut to length on that end which is opposite the end which is sealed to be fluid-tight.

In a preferred embodiment of the method, the cold forming process is used for shaping a driver edge surrounding the tube opening at the front at the end region of the blank. For this purpose, at least a part of the mounting region will be formed as at least a part of the driver edge. The driver edge serves for a cold forming process to form the blank into the cylinder tube, in particular the ironing process, i.e. securing the blank on a mandrel when this is ironed with the help of a forming die. The mounting region will in this case in particular be suitably designed for welding as a welding region, by sizing the driver edge appropriately. In other words, a driver edge will therefore be created that will not simply serve the actual purpose as driver edge, but can fulfill a dual function as mounting region, particularly welding region. The driver edge will therefore be sized larger or be produced with a greater volume or with advanced material characteristics, for example, than would be necessary for the actual ironing process or forming operation.

In a further preferred embodiment of the method, the mounting region together with at least a part of the cylinder tube will be produced or completed from the blank in a single process step of the cold forming process. Consequently, for example particularly after molding the driver edge on the blank and threading the blank onto a mandrel, the blank is ironed starting from the corresponding front end. In this context, the region of the driver edge as well as the region of the cylinder tube adjacent thereto is ironed at the same time and thus the mounting region in the region of the driver edge will also be treated, in particular be completed, together with at least a part of the cylinder tube.

In a further preferred embodiment of the method, the blank will be formed in such a way that according to the type of a lightweight component, a greater wall thickness and/or strength is created in the region of a force and/or welding node than in the remaining cylinder tube. According to this embodiment of the method it is possible to produce the cylinder tube as a lightweight component that will meet stress and load requirements and is cost-effective. In this manner, the advantages of the cold forming process, in particular the ironing process, for the production of lightweight components are combined with the particularly simple manner of the invention of sealing the cylinder tube to be fluid-tight on the front end. Special features and advantages of using an ironing process for producing tubular lightweight components can be found in DE 10 2007 045 719 A1 of the applicant, for example. The proposed variants and possibilities therein can particularly also be transferred to the present method or be utilized here.

In a preferred variant of the aforementioned embodiment, the blank is formed in a first region or axial region axially adjoining the end section in the manner of a lightweight component in such a way that the first region is formed with reduced wall thickness. In other words, the first region relative to the other regions of the cylinder tube, is designed thin-walled. In the case of a shock absorber tube, the first region then serves as piston bearing surface. This process variant would be particularly suitable to produce both the first region as well as also the mounting region in one single process step, according to the above. In particular, both regions will be ironed by means of a single first die, wherein then a relative thick-walled force or weld node is created in the mounting region.

In a further preferred variant of the above-mentioned embodiment, the blank in a second axial region is formed in such a way that the second region is formed as a mechanically robust attachment region in the style of a lightweight component. In particular, the second region is a region or axial region that is axially adjoining the first region which, relative to the other regions of the cylinder tube, particularly to the first region, is designed thick-walled. Consequently, a force or welding node forms in the second region, which, when used as a shock absorber tube, serves for mounting of the piston rod guide.

In a further preferred process variant, the cold forming process, in particular in the end region, and in the first and second region, is performed together on an identical mandrel that is inserted in the blank. The mandrel is in particular circular cylindrical, i.e. it has a constant diameter at least in the region of the cylinder tube to be produced. In this context, a constant diameter or a circular cylindrical form also includes forms which are designed to be slightly conical in order to facilitate the detachment of the cylinder tube from the mandrel in the known manner, after the formation is completed. The formed blank is then usually stripped off from the mandrel prior to attaching the end piece on the mounting region, according to the invention, in particular prior to the welding.

In a particularly preferred embodiment of the method, such an end piece is used that comprises a fork holder or ring mounting of a shock absorber. In other words, the known fork holder or ring mounting of the shock absorber will therefore be attached onto the end piece or is designed together with this, which in turn can occur prior or after attaching the end piece on the cylinder tube.

In a particularly preferred variant of this embodiment, such an end piece is used that forms a center part of a fork holder. In this context, the fork holder is particularly designed as one piece with the end piece. A corresponding fork holder is normally designed U-shaped and ribbon-shaped. The center part of the fork holder then fulfills a dual function as end piece of the cylinder tube.

In a further variant of the above-mentioned embodiment, such an end piece which forms a disk that is attached to the ring mounting is used. In other words, the ring mounting is therefore attached on the disk, in particular by welding. Here, a fluid-tight welding is not necessary, since leakproofness is already created between the disk and the cylinder tube.

In respect of the cylinder tube, the objective of the invention is solved by a cylinder tube sealed to be fluid-tight on the end, according to claim 11. Advantageous developments are cited in the associated sub-claims. The cylinder tube together with its embodiments and advantages was already explained in conjunction with the method as taught by the invention, wherein the respective subject matter related features are provided by means of the method.

As already mentioned above, the method as taught by the invention can particularly be used for producing a shock absorber tube for a shock absorber of a motorized vehicle as cylinder tube.

The cylinder tube as taught by the invention can be used correspondingly as shock absorber tube for a shock absorber of a motorized vehicle.

### BRIEF DESCRIPTION OF THE VIEWS OF THE DRAWINGS

For an additional description of the invention, please refer to the exemplary embodiments in the drawings, which show as a schematic representation in each case:

FIG. 1 shows a cylinder tube as a shock absorber tube with fork holder according to the invention,

FIG. 2 shows part of an alternative cylinder tube with ring mounting,

FIG. 3 shows a tubular blank for the method according to the invention,

FIG. 4 shows molding a driver edge on the blank from FIG. 3,

FIG. 5 shows the cold forming of an end region and a first region of the cylinder tube,

FIG. 6 shows the cold forming of a second region of the cylinder tube,

FIG. 7 shows the finally processed cylinder tube,

FIG. 8 shows the fluid-tight sealing on the front end by attaching an end piece onto the cylinder tube from FIG. 7,

FIG. 9 shows the sealing of the cylinder tube with an alternative end piece.

### DETAILED DESCRIPTION OF THE INVENTION

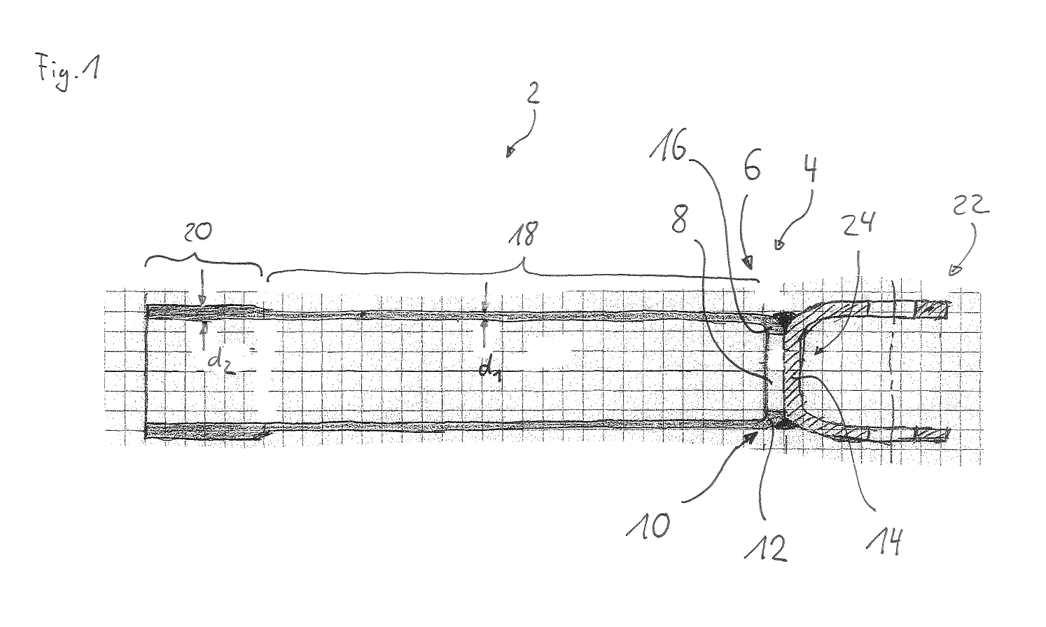

FIG. 1 shows a cylinder tube 2 which is sealed as to be fluid-tight on its front end 2. In the example, the cylinder tube is a shock absorber tube of a shock absorber of a motorized vehicle. The cylinder tube 2, as explained further below, is transformed from a tubular blank 30 by means of a cold forming process, which is the sheet metal deep-drawing here. The cylinder tube comprises an opening 8 in an end region 6 located on the front end 4. In the end region 6 of the cylinder tube 2, a driver edge surrounding the opening 8 is shaped for a cold forming process, with a cold forming process, here an ironing process 16. A radial outer edge region 10 of the end region 6 represents a mounting region 12, which is a welding region in the example. An end piece 14 which seals the opening 8 to be fluid-tight is attached on the mounting region 12 fluid-tight, and in the present case is welded gas-tight.

In this case, a part of the mounting region 12 is formed as part of the driver edge 16. The remainder of the mounting region 12 extends into the cylinder tube 2 or its first axial region 18. In the example, the blank 30 is formed to the cylinder tube 2 such, that in the style of a lightweight component, greater wall thicknesses and strengths are provided in the region of force and/or welding nodes on the cylinder tube than in other regions of the cylinder tube. In particular, a first region 18 of the cylinder tube 2 is formed axially adjoining the end region 6, in the style of a lightweight component with reduced wall thicknesses. Moreover, a second axial region 20, which adjoins the first region 18, is formed on the cylinder tube 2 in the manner of a lightweight component as mechanically robust attachment region.

In the example, a fork holder 22 is attached on the cylinder tube 2, said holder having a one-piece design and the center part 24 of which is the end piece 14. In the example, the wall thickness in the first region 18 is d₁=1.2 mm, in the second region 20 the wall thickness is d₂=1.7 mm; decisive is that the wall thickness in region 18 is less than the one in region 20. Here too, different material strengths result. In the example, the first region 18 represents a piston bearing surface of the shock absorber, and the second region 20 represents an attachment region for the piston rod guide. Any numerical data in this description must be understood to be merely examples. The overall result of such type of sizing is a weight saving of 20%-30% on the cylinder tube 2, because of the lightweight component design, contrary to a conventional component, which would comprise equivalent material strength everywhere as in the second region 20.

FIG. 2 shows a section of the cylinder tube 2 from FIG. 1, but with a ring mounting 26 instead of the fork holder 22. Alternatively to the embodiment pursuant to FIG. 1, here the end piece 14 is also a disk 28 attached fluid-tight by welding onto the mounting region 12. The disk 28 is attached again to the ring mounting 26, in the present case by welding. In this context, the latter weld does not have to be fluid-tight.

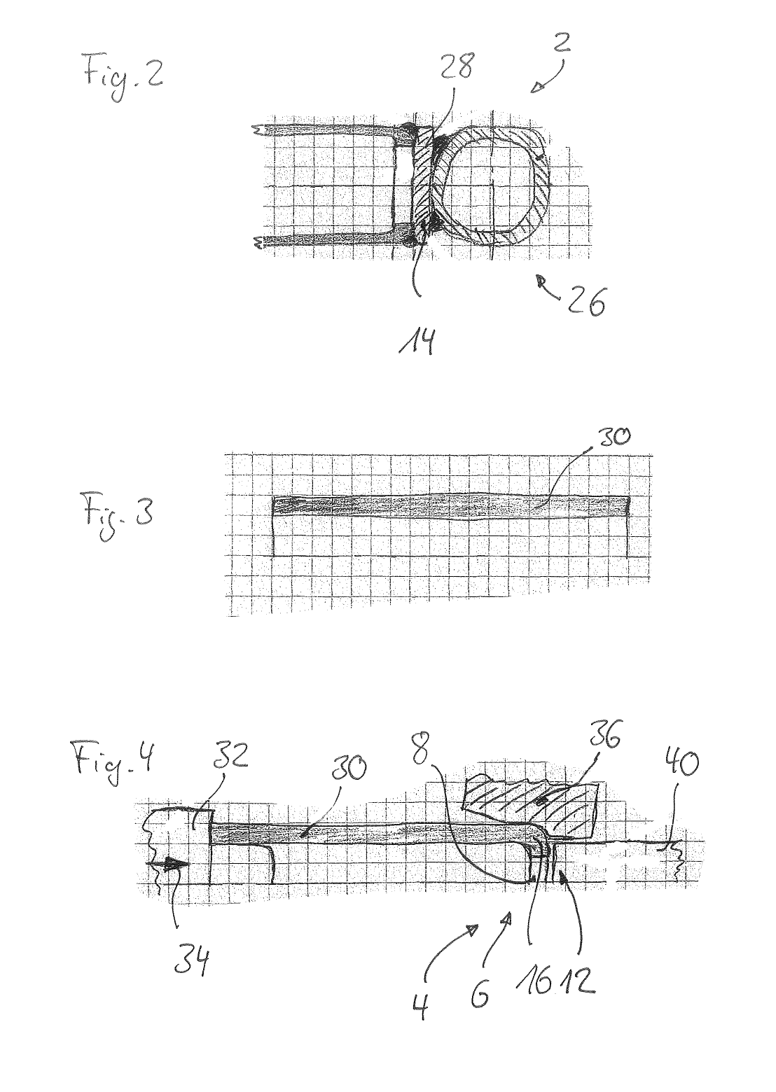

FIG. 3 shows a tubular blank 30, which serves as starting material for producing a cylinder tube 2 pursuant to FIG. 1 or 2. The blank 30 has dimensions of 42 mm×2.5 mm and complies with DIN EN 10305-3, E235 +M or E235 +CR1.

FIG. 4 shows how a driver edge is molded on blank 30 from FIG. 3 in its end region 6, i.e. on the front end 4, in a first process step. For this purpose, the blank 30 is pressed into a die 36 by means of a plunger 32 in the direction of the arrow 34, i.e. in the axial direction of the blank 30 or the cylinder tube 2. The blank 30 arches radially inward on the front end 4, so that the driver edge 16 forms. In this context, an opening 8 remains on the front end 4, which is bounded by the driver edge 16. The plunger 32 is subsequently retracted opposite to the direction of the arrow 34, and the blank 30 is removed by means of an ejector 40 from the die 36 opposite to the direction of the arrow 34. The ejector 40 can then be retracted again in the direction of the arrow 34. By molding the driver edge 16, the mounting region 12 will already be prepared. For this purpose, the driver edge is sized sufficiently large, tough, etc., with respect to the blank 30 and the forming.

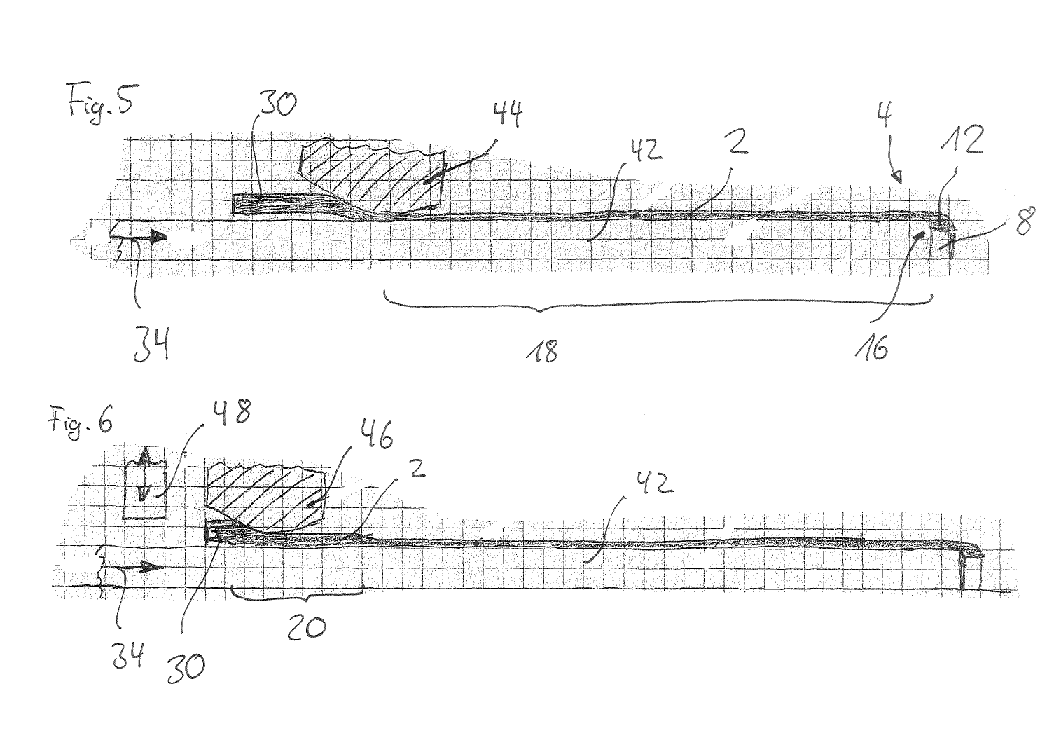

FIG. 5 shows how the first region 18 of the cylinder tube 2 is cold formed, here ironed. Pursuant to FIG. 4, the blank 30 is threaded onto a mandrel 42, and subsequently a die 44 is drawn starting from the front end 4 across the blank 30 in the opposite direction of the arrow 34. In this context, in region 18 the blank 30 forms into the cylinder tube 2. At the same time, the mounting region 12 is also completed, in that this is also introduced in the region of the driver edge 16 and in the adjoining part of the region 18 to the appropriate outside diameter by means of the die 44.

FIG. 6 shows how the second region 20 of the cylinder tube 2 is formed on the same mandrel 42 from the blank 30. Here, a further die 46 with a larger inner diameter that is different from die 44, is used. This is also moved again opposite to the direction of the arrow 34. Because of the same cylindrical mandrel 42, which has the same diameter at least in the regions 20 and 18, and the larger inner diameter of the second die 46, a greater wall thickness for the cylinder tube 2 remains in region 20 than in region 18 and in end region 6. After conclusion of the stretching operation, the die 46 is pulled off from the cylinder tube 2 in the direction of the arrow 34, and a wiper 48 is used in a known manner, which is not explained in greater detail, to strip off the cylinder tube 2 from the mandrel 42 in the direction of the arrow 34. In this context, the wiper 48 can be moved radially, as indicated by a double-headed arrow.

FIG. 7 shows how, based on FIG. 6 the cylinder tube 2 is finished, in that the remainder of the blank 30 is cut off on the end 50 that is opposite of the front end 4, and appropriate finishing takes place.

Strictly speaking, the “cylinder tube 2,” i.e. according to FIG. 7 that was produced up to this point, is merely a tubular body, that is only completed to the actual finished cylinder tube 2 by the application of the end piece 14. For the purpose of an easier presentation and legibility of the text, it was decided to dispense with this distinction, however.

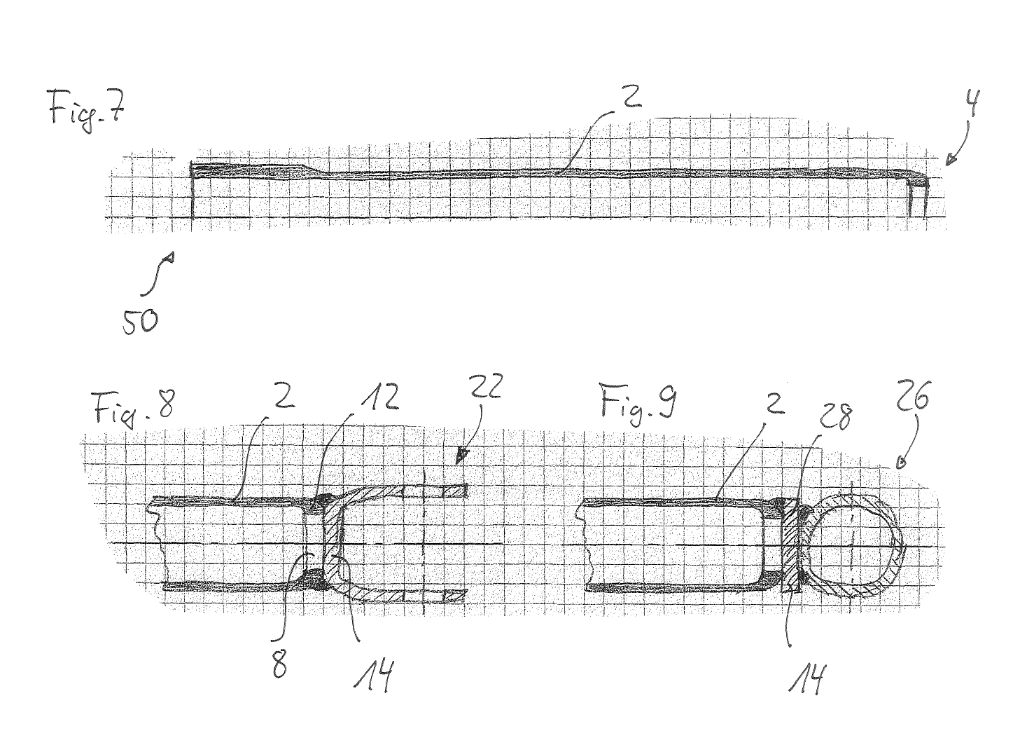

FIG. 8 shows finally, based on FIG. 7, the completion of the cylinder tube 2. The fork holder 22 and therefore the end piece 14 that was already explained in context with FIG. 1 is then attached to be fluid-tight on the mounting region 12, and in the present case is welded on gas-tight. Consequently, the opening 8 and therefore the end of the cylinder tube 2 is sealed to be fluid-tight on the front end 4, at the same time.

FIG. 9, based on FIG. 7, according to FIG. 2 shows the fluid-tight attaching, here likewise the gas-tight welding-on of the end piece 14 in form of a disk 28, with the ring mounting 26 in turn welded to it.

### LIST OF REFERENCE SYMBOLS

2 Cylinder tube

4 Front end

6 End region

8 Opening

10 Edge region

12 Mounting region

14 End piece

16 Driver edge

18 First region

20 Second region

22 Fork holder

24 Center part

26 Ring mounting

28 Disk

30 Blank

32 Plunger

34 Arrow

36 Die

40 Ejector

42 Mandrel

44 Die

48 Wiper

50 End

d_{1,2} Wall thickness

1. A method for producing a cylinder tube (2), which is closed at an end so as to be fluid-tight, for a shock absorber tube of a shock absorber of a motorized vehicle, from a tubular blank (30), characterized by the following steps:
(a) forming the blank (30) into a cylinder tube (2) by means of a sheet metal deep-drawing cold forming process with an opening (8) remaining in the cylinder tube (30) on an end region (6) of the cylinder tube (2),
(b) producing a mounting region (12) in a radially outer edge region (10) of the end region (6),
(c) sealing the cylinder tube (2) in fluid-tight attachment by welding of an end piece (14) to the mounting region (12), said end piece closing the opening (8) to be fluid-tight.

2. The method according to claim 1, in which with the cold forming process a driver edge (16), which surrounds the opening (8) for the cold forming process forming the blank (30) into the cylinder tube (2), is shaped on the end region (6) of the blank (30), and at least a part of the mounting region (12) is shaped as at least a part of the driver edge (16).

3. The method according to claim 2, in which the mounting region (12) together with at least a part of the cylinder tube (2), is produced in a single process step of the cold forming process.

4. The method according to claim 3, in which the blank (30) is formed as a lightweight component, and a greater wall thickness (d_{1, 2}) or strength is created in the region of a force or welding node than in the remaining cylinder tube (2).

5. The method according to claim 4, in which the blank (30) in a first region (18) following an end region (6) is formed as a lightweight component and the first region (18) is shaped with reduced wall thickness.

6. The method according to claim 4, in which the blank (30) in a second region (20) is formed as a mechanically robust attachment region and as a lightweight component.

7. The method according to claim 6, in which the cold forming process, in the end region (6) and in the first (18) and second region (20) is performed on an identical mandrel (42) that is inserted in the blank (30).

8. The method according to claim 7 wherein, an end piece (14) is used that comprises a fork holder (22) or ring mounting (26) of a shock absorber.

9. The method according to claim 8, wherein an end piece (14) is used that forms a central part (24) of a fork holder (22).

10. The method according to claim 8, wherein an end piece (14) is used which forms a disk (28) attached onto a fork holder (22).

11. A cylinder tube (2) that is sealed to be fluid-tight on a front end, for a shock absorber tube of a shock absorber of a motorized vehicle and comprising:
the cylinder tube (2) being formed from a tubular blank (30) with the aid of a cold forming process by sheet metal deep-drawing, and including
an opening (8) on one end region (6) on the front end,
a mounting region (12) in a radial outer edge region (10) of the end region (6) and,
an end piece (14) that seals the opening (8) to be fluid-tight and that is attached fluid-tight on the mounting region (12) by welding.

12. The cylinder tube (2) according to claim 11, in which a driver edge (16) surrounding the opening (8) and shaped with the cold forming process on the end region (6) of the blank (30) is shaped for a sheet metal deep-drawing process, and at least one section of the mounting region (12) is shaped as at least one section of the driver edge (16).

13. The cylinder tube (2) according to claim 12, in which the blank (30) is formed as a lightweight component having a greater wall thickness (d_{1, 2}) or strength in the region of a force or welding node than in the remaining regions of the cylinder tube (2).

14. The cylinder tube (2) according to claim 13, in which the blank (30) in a first region (18) adjoining an end region (6) is formed as a lightweight component and the first region (18) is shaped with reduced wall thickness.

15. The cylinder tube (2) according to claims 14, in which the blank (30) in a second region (20) is formed as a mechanically robust attachment region as a lightweight component.

16. The cylinder tube (2) according to claim 15, in which the end piece (14) comprises a fork holder (22) or ring mounting (26) of a shock absorber.

17. The cylinder tube (2) according to claim 16, in which a center part (24) of the fork holder (22) is the end piece (14).

18. The cylinder tube (2) according to claim 16, in which the end piece (14) is a disk (28) attached on a ring mounting (26).

19. (canceled)

20. (canceled)
